(19) United States
(12) Patent Application Publication
(10) Pub. No.: US 2026/0278032 A1
(43) Pub. Date: Sep. 17, 2026

(54) METHOD, PRODUCT AND DEVICE FOR REVEALING CHLORIDE DISTRIBUTION IN CONCRETE DIFFUSION ZONE

(71) Applicant: Taizhou university, Taizhou (CN)

(72) Inventors: Chuang He, Taizhou (CN); Jiwei Li, Taizhou (CN)

(21) Appl. No.: 19/251,681

(22) Filed: Jun. 26, 2025

(30) Foreign Application Priority Data
Mar. 11, 2025 (CN) 202510288575.6

(51) Int. Cl. G06F 17/11; G06F 17/18

(52) U.S. Cl. CPC G06F 17/11; G06F 17/18

(57) ABSTRACT

The present disclosure provides a method, product, and device for revealing chloride distribution in a concrete diffusion zone, falling within the technical field of construction. In the present disclosure, an intrinsic curve of chloride concentration distribution in the concrete diffusion zone can be deduced, and the applicability is strong, thereby solving the limitation that a traditional chloride transmission model cannot be universally used.

### CROSS-REFERENCE TO RELATED APPLICATION

This application claims priority of Chinese Patent Application No. 202510288575.6, filed on Mar. 11, 2025, the entire contents of which are incorporated herein by reference.

### TECHNICAL FIELD

The present disclosure relates to the technical field of construction, and in particular to a method, product and device for revealing chloride distribution in a concrete diffusion zone.

### BACKGROUND

In coastal environments, chloride erosion is one of the main causes of reinforced concrete structure deterioration. With time, chloride ions gradually enter the interior of concrete through the diffusion process, accumulating near the surface of the rebar. When the concentration of chloride reaches or exceeds the threshold, the rebar begins to corrode and causes concrete structure expansion and cracking, which constitutes irreversible damage to the durability of buildings and infrastructure.

To predict and evaluate the durability of concrete structures during long-term service, the diffusion behavior and concentration distribution of chloride ions in concrete diffusion zones are usually concerned. However, because chloride diffusion is affected by many factors, such as concrete composition, environmental conditions, and structural life, it is challenging to establish a universal prediction model.

At present, there are many prediction models used to describe the diffusion process of chloride in concrete, mainly divided into two categories: a mechanism model and an engineering model. The mechanism model integrates the key processes of diffusion, osmosis, water absorption, and chloride binding, and can predict chloride transport accurately. However, these models require complex experiments to obtain the necessary data, and with the increase of input parameters, the reliability will also decrease. This increases testing and modeling difficulties. In contrast, the engineering model simplifies these processes into a unified equation, assumes diffusion is the transport mechanism, and only knowing the apparent chloride diffusion coefficient (Dapp) and the chloride boundary concentration can map chloride distribution, and it is the most widely used model in the engineering field. However, the engineering model only fits chloride distribution for specific engineering, because different working conditions are different, so it is not universal. Therefore, it is necessary to develop a high-precision and universal calculation model of chloride distribution in the concrete diffusion zone.

Transformation Group theory offers new ideas to solve these problems. Transformation group theory is used to describe system symmetry and consequent conservation laws. Since diffusion equations such as Fick's law often exhibit symmetry in every case, transformation group theory can be used to describe chloride diffusion. The similar solutions of these equations can be determined by transformation groups, and invariant solutions under specific groups are explored. Therefore, based on transformation group theory, a general prediction method of chloride concentration distribution is expected to be developed to obtain the intrinsic curve of chloride concentration distribution suitable for various operating conditions.

### SUMMARY

An objective of the present disclosure is to solve one of the above technical problems in the related art at least to a certain extent.

Therefore, the objective of the present disclosure is to provide a method, product and device for revealing chloride distribution in a concrete diffusion zone, which can deduce an intrinsic curve of chloride concentration distribution in a concrete diffusion zone, has high applicability, and solves the limitation that the traditional chloride transport model cannot be used universally.

In order to solve the above technical problems, the present disclosure is implemented as follows.

An example of the present disclosure provides a method for revealing chloride distribution in a concrete diffusion zone, including the steps of:
determining a nonlinear diffusion equation capable of expressing chloride diffusion in concrete;
determining a single parameter transformation group to be introduced, and substituting the single parameter transformation group into the nonlinear diffusion equation to obtain a first transformation formula;
solving, for the first transformation formula, the equation according to a conformal invariance condition, a given initial condition, and a boundary condition when a chloride diffusion coefficient is constant, and obtaining an analytical expression of chloride concentration distribution when the chloride diffusion coefficient is constant; and/or,
solving, for the first transformation formula, the equation according to a conformal invariance condition, a given initial condition, and a boundary condition when the chloride diffusion coefficient changes with time, and obtaining a first analytical expression of chloride concentration distribution when the chloride diffusion coefficient changes with time.

In addition, the method for revealing chloride distribution in a concrete diffusion zone according to the present disclosure may also have the following additional technical features.

In some of these examples, the conformal invariance condition when the chloride diffusion coefficient is constant is as follows:
β₁=2β₂ and β₃ are arbitrary constants; β₁, β₂ and β₃ are indexes to be determined for time t, penetration depth x, and concentration C in the single parameter transformation group; and
invariant transformation conditions:

$$λ = \frac{x}{{t}^{{β}_{2} / {β}_{1}}} , f = \frac{C}{{t}^{{β}_{3} / {β}_{1}}} .$$

In some of these examples, the initial conditions when the chloride diffusion coefficient is constant and when the chloride diffusion coefficient varies with time are as follows:

$$C ( 0 , x ) = {C}_{i}$$

the boundary conditions are:

$$\{ \begin{matrix}C ( t , 0 ) = {C}_{0} \\ C ( t , ∞ ) = {C}_{i}\end{matrix}$$

where C₀ is a concentration corresponding to a chloride penetration depth x=0, and Cᵢ is a concentration corresponding to a depth of chloride penetration x=i.

In some of these examples, an expression of the chloride diffusion coefficient D changing with time is as follows:

$$D = {{D}_{t e s t} ( \frac{{t}_{t e s t}}{t} )}^{m}$$

where tₜₑₛₜ is a test time, Dₜₑₛₜ is a corresponding diffusion coefficient at the test time tₜₑₛₜ, and m is an age coefficient.

In some of these examples, the conformal invariance condition when the chloride diffusion coefficient changes with time is as follows:
(1+m)β₁=2β₂ and β₃ are arbitrary constants;
where β₁, β₂ and β₃ are indexes to be determined for time t, penetration depth x, and concentration C in the single parameter transformation group, and m is the age coefficient.

In some of these examples, the method further includes the steps of:
determining an approximately invariant transformation, and substituting the approximately invariant transformation into the nonlinear diffusion equation to obtain a second transformation formula; and
solving, for the second transformation formula, the equation according to initial and boundary conditions to obtain the second analytical expression of chloride concentration distribution when the chloride diffusion coefficient changes with time.

In some of these examples, the approximate invariant transformation is as follows:

$$λ = \frac{x}{{t}^{n}} , C = C ( λ )$$

where n is a time index to be determined, t is time, x is penetration depth, and C is a chloride concentration.

In some of these examples, a relationship between the chloride diffusion coefficient and concentration and time is calibrated as follows:
a chloride concentration is a function of an independent variable

$$λ = \frac{x}{{t}^{n}} ,$$

the distribution law of chloride concentration is calibrated by determining the time index n, and the relationship between the chloride diffusion coefficient and concentration and time is determined; and
a determination process of the value of n includes the steps of: recording the maximum depth of chloride penetration as x_{f}, and a required time as t_{f}; deriving

$${x}_{f} = {λ}_{f} {t}_{f}^{n}$$

based on

$$λ = \frac{x}{{t}^{n}} ;$$

taking the given data point (tᵢ, x_{fi}), where x_{f} is an infiltration depth of chloride in concrete at tᵢ; searching, for n∈[0, 1], nᵢ with a certain step size, and making x_{f}=λT, T=tⁿ; fitting a straight line x_{f}=λT using linear regression for each nᵢ based on the data point (tᵢ, x_{fi}); and choosing the nᵢ that best fits the data point to a straight line as the time index n.

An example of the present disclosure also provides a computer program product, including a computer program, which, when executed by a processor, implements the steps of the method for revealing chloride distribution in a concrete diffusion zone as described in any one of the above.

An example of the present disclosure further provides a computer device, including a memory, a processor, and a computer program stored on the memory and executable on the processor. The processor executes the computer program to implement the steps of the method for revealing chloride distribution in a concrete diffusion zone as described in any one of the above.

Compared with the related art, the present disclosure has at least the following beneficial effects.

In the example of the present disclosure, the method for revealing chloride distribution in a concrete diffusion zone is provided, and the intrinsic curve of chloride concentration distribution in concrete diffusion zone can be deduced, which has not been realized in the related art. Through this curve, the chloride concentration distribution under long-term service conditions can be predicted, thereby helping to evaluate the long-term durability of concrete structures.

In the example of the present disclosure, the method for revealing chloride distribution in a concrete diffusion zone is provided: due to the different types of cement used, curing time, exposed areas (immersion zone, tidal zone, splash zone, and atmospheric zone), and exposed chloride concentrations under different working conditions, the D values of concrete under different working conditions are different. Therefore, the traditional engineering model of chloride distribution requires solving a chloride diffusion coefficient D value for concrete under different working conditions, which leads to a lack of universality. In comparison, the method of the present disclosure introduces transformation group theory and only considers three variables: chloride infiltration depth, time, and chloride concentration, without considering solving Dapp. Therefore, the method of the present disclosure is suitable for various types of concrete and various working conditions, overcoming the limitation that the traditional chloride concentration prediction model can only be used under specific working conditions.

In the example of the present disclosure, a method for revealing chloride distribution in a concrete diffusion zone is provided, in practical engineering, D varies greatly with time, and it is extremely difficult to accurately calibrate D. The uncertainty of D and the approximation of the numerical method greatly affect the accuracy of the numerical solution, which leads to inaccurate prediction of chloride concentration. In the present disclosure, the group transformation theory is innovatively applied, and only three variables of chloride infiltration depth, time, and chloride concentration need to be considered, and the fitting accuracy of chloride distribution is significantly improved. Therefore, the challenge brought by the change of D with time in practical engineering can be effectively met, and the error caused by parameter uncertainty is reduced, thereby providing more reliable chloride distribution.

Additional solutions and advantages of the present disclosure will be set forth in part in the description which follows, and in part will be obvious from the description which follows, or may be learned by practice of the present disclosure.

### BRIEF DESCRIPTION OF THE DRAWINGS

FIG. 1 is a flow chart of a method for revealing chloride distribution in a concrete diffusion zone according to an example of the present disclosure;

FIG. 2 is a chloride concentration distribution curve in working condition 1 according to Example 1 of the present disclosure;

FIG. 3 is a chloride concentration distribution curve in working condition 2 according to Example 1 of the present disclosure;

FIG. 4 is a chloride concentration distribution curve in working condition 3 according to Example 1 of the present disclosure;

FIG. 5 is a chloride concentration distribution curve after 3 days of curing according to Example 2 of the present disclosure;

FIG. 6 is a chloride concentration distribution curve after 7 days of curing according to Example 2 of the present disclosure;

FIG. 7 is a chloride concentration distribution curve after 14 days of curing according to Example 2 of the present disclosure; and

FIG. 8 is a chloride concentration distribution curve after 28 days of curing according to Example 2 of the present disclosure.

### DETAILED DESCRIPTION

Technical solutions in the examples of the present disclosure will be described clearly and completely in the following with reference to the attached drawings in the examples of the present disclosure. Obviously, all the described examples are only some, rather than all examples of the present disclosure. Based on the examples in the present disclosure, all other examples obtained by those ordinary skilled in the art without creative efforts belong to the protection scope of the present disclosure.

The examples of the present disclosure will be described in detail below through specific examples and application scenarios with reference to the accompanying drawings.

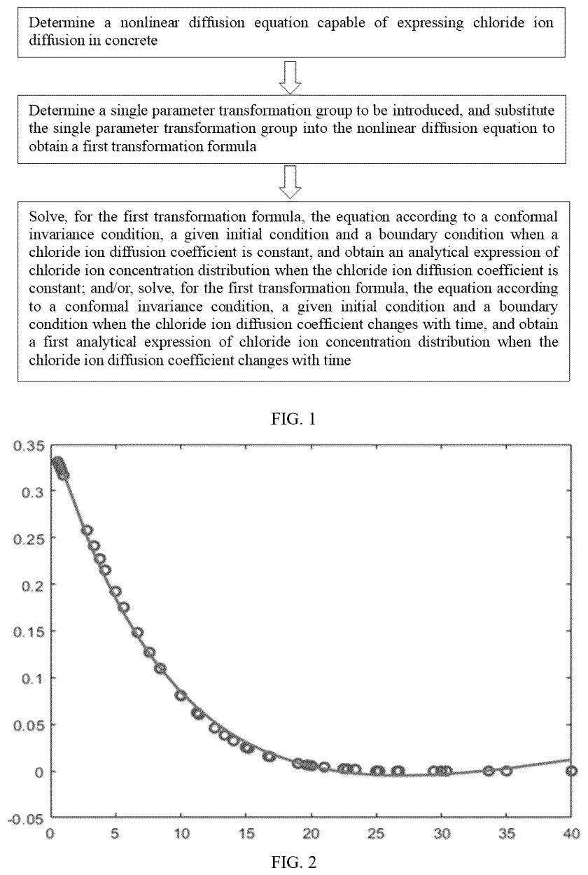

Referring to FIG. 1, in some examples of the present disclosure, a method for revealing chloride distribution in a concrete diffusion zone is provided. A nonlinear diffusion equation of complex partial differential is given. Mathematical transformation is used to reduce the dimension of the complex partial differential equation to an ordinary differential equation or an algebraic problem. Parameters are calibrated in combination with experimental data, and finally, the prediction of chloride diffusion behavior is realized. Specific technical solutions implemented include the following steps.

The following nonlinear diffusion expression is used to determine the chloride diffusion in concrete:

$$\frac{\partial C}{\partial t} = \frac{\partial }{\partial x} ( D ( C ) \frac{\partial C}{\partial x} ) \qquad ( 1 )$$

where D is a chloride diffusion coefficient, C is a chloride concentration [mol/L], t is time [T], and x is a position coordinate [L]. The left side of the equation represents a rate of change of chloride concentration with time, and the right side is a diffusion term, which reflects the diffusion behavior of chloride due to the concentration gradient. This equation is a starting point for analyzing the chloride diffusion problem. Its nonlinearity comes from the diffusion coefficient D which may vary with concentration or time. All subsequent analyses (such as conformal invariance, and transformation group introduction) are developed around this equation.

In order to analyze the conformal invariance of equation (1), the following single-parameter transformation group is introduced:

$$τ = {a}^{{β}_{1}} t , ξ = {a}^{{β}_{2}} x , Θ = {a}^{{β}_{3}} C \qquad ( 2 )$$

where a is a non-zero real constant, which plays a scaling role in the transformation; βᵢ(i=1,2,3) is an index to be determined, which is used to keep the transformed form of the equation unchanged. This equation introduces the single-parameter transformation group and performs scaling transformation on time t, penetration depth x, and concentration C. By scaling transformation, the conformal invariance of equation (1) is explored (that is, the equation remains unchanged after transformation), which means that there is a self-similar solution and can simplify the analytical solution process.

The substitution into equation (1) gives:

$${{a}^{{β}_{1}}}^{- {β}_{3}} \frac{\partial Θ}{\partial τ} = {a}^{2 {β}_{2} - {β}_{3}} \frac{\partial }{\partial ξ} ( D \frac{\partial Θ}{\partial ξ} ) \qquad ( 3 )$$

by comparing the equations before and after transformation, the relationship of the index to be determined can be deduced, and the condition of conformal invariance can be determined (that is, the following equation (5)).

When D is a constant, equation (3) can be written as:

$${a}^{{β}_{1} - {β}_{3}} \frac{\partial Θ}{\partial τ} = {a}^{2 {β}_{2} - {β}_{3}} D \frac{{\partial }^{2} Θ}{\partial {ξ}^{2}} \qquad ( 4 )$$

on the premise that D is a constant, the diffusion term on the right side of the equation contains only the spatial second derivative. In order to make equation (4) and equation (1) conformally invariant, the following conditions are satisfied:

$${β}_{1} - {β}_{3} = 2 {β}_{2} - {β}_{3} \qquad ( 5 )$$

that is:
β₁=2β₂ and β₃ is an arbitrary constant (6)
when considering the change with time, the equation (1) is conformal and invariant, and the corresponding invariant transformation is:

$$λ = \frac{x}{{t}^{{β}_{2} / {β}_{1}}} , f = \frac{C}{{t}^{{β}_{3} / {β}_{1}}} \qquad ( 7 )$$

since β₃ is an arbitrary constant, β₃=0 can be used to simplify the problem.

Therefore, transformation (7) simplifies to:

$$λ = \frac{x}{{t}^{{β}_{2} / {β}_{1}}} , C = C ( λ ) \qquad ( 8 )$$

according to equation (6), it can be seen that equation (8) is written as:

$$λ = \frac{x}{\sqrt{t}} , C = C ( λ ) \qquad ( 9 )$$

by combining equation (9) with initial and boundary conditions, an analytical expression (equation (12)) of the chloride concentration distribution of equation (1) can be obtained.

The initial condition is:

$$C ( 0 , x ) = {C}_{i} \qquad ( 10 )$$

the boundary condition is:

$$\{ \begin{matrix}C ( t , 0 ) = {C}_{0} \\ C ( t , ∞ ) = {C}_{i}\end{matrix} \qquad ( 11 )$$

the analytical expression for the chloride concentration distribution is:

$$C ( x , t ) = {C}_{i} + ( {C}_{0} - {C}_{i} ) erfc ( \frac{x}{2 \sqrt{Dt}} ) \qquad ( 12 )$$

in practical engineering, the diffusion coefficient D changes with time, as shown in equation (13):

$$D = {{D}_{test} ( \frac{{t}_{test}}{t} )}^{m} \qquad ( 13 )$$

where Dₜₑₛₜ is a corresponding diffusion coefficient at a test time tₜₑₛₜ, and m is an age coefficient.

To simplify calculation, the equation (13) is simplified to:

$$D = {D}_{0} {t}^{m} \qquad ( 14 )$$

the equation (1) can be written at this time:

$$\frac{\partial C}{\partial t} = \frac{\partial }{\partial x} ( {D}_{0} {t}^{m} \frac{\partial C}{\partial x} ) \qquad ( 15 )$$

combining the equations (1)-(3), it can be seen that:

$${a}^{{β}_{1} - {β}_{3}} \frac{\partial Θ}{\partial τ} = {a}^{2 {β}_{2} - {β}_{3} - m {β}_{1}} \frac{\partial }{\partial ξ} ( {D}_{0} {τ}^{m} \frac{\partial Θ}{\partial ξ} ) \qquad ( 16 )$$

to make the equation (15) and the equation (16) conformally invariant, the conditions are satisfied:

$${β}_{1} - {β}_{3} = 2 {β}_{2} - {β}_{3} - m {β}_{1} \qquad ( 17 )$$

that is:
(1+m)β₁=2β₂ and β₃ is an arbitrary constant, and m is the age coefficient whose value depends on the composition of the concrete.

When considering the change with time, the equation (15) is conformal and invariant, and the corresponding invariant transformation is:

$$λ = \frac{x}{{t}^{{β}_{2} / {β}_{1}}} , f = \frac{C}{{t}^{{β}_{3} / {β}_{1}}} \qquad ( 18 )$$

since β₃ is an arbitrary constant, to simplify the problem, let β₃=0.

Therefore, transformation (18) simplifies to:

$$λ = \frac{x}{{t}^{\frac{( 1 + m )}{2}}} , C = C ( λ ) \qquad ( 19 )$$

λ is a function related to the time t and the chloride penetration depth x; and f represents a function related to the time t and the chloride concentration, that is, C in the equation (19). Since it is assumed here that β₃=0, f is not related to the time t, but only to the concentration. Therefore, C=C(λ) is written in the equation (19). C(λ) represents that the chloride concentration is a function related to λ, in other words, C is related to the time t and the chloride infiltration depth x.

When D₀ is a constant, the chloride distribution can be obtained by using transformation (19) and initial and boundary conditions (10) and (11):

$$C ( x , t ) = {C}_{i} + ( {C}_{0} - {C}_{i} ) erfc ( \frac{x \sqrt{1 + m}}{2 \sqrt{Dt}} ) \qquad ( 20 )$$

It is to be noted that the invariant transformations (8) and (19) are obtained when D is constant. In actual engineering, the form of D changing with time is extremely complex. To this end, consider introducing the following approximately invariant transformation:

$$λ = \frac{x}{{t}^{n}} , C = C ( λ ) \qquad ( 21 )$$

where n is a time index to be determined.

The equation (1) can be changed into equation (22) by transforming the equation (21):

$$\frac{d}{d λ} ( D ( C , t ) \frac{dC}{d λ} ) + n λ {t}^{2 n - 1} \frac{dC}{d λ} = 0 \qquad ( 22 )$$

Combined with the initial and boundary conditions, the chloride concentration distribution law can be obtained by numerical method equation (22), but a functional relationship of D(C,t) is given. D(C,t) is a relationship function between the chloride diffusion coefficient and concentration as well as time. Because accurate calibration of D is extremely difficult in practical conditions, the uncertainty of D and the inherent approximation of the numerical solution method inevitably lead to inaccurate determination of chloride concentration. Therefore, in the present disclosure, the specific functional relationship of D(C,t) is not sought, but the following calibration method is adopted.

The calibration method of D(C,t) is as follows: by observing the transformation (21), it can be seen that the chloride concentration is a function of an independent variable

$$λ = \frac{x}{{t}^{n}} ,$$

and the distribution law of chloride concentration C can be calibrated only by determining the value of time index n here.

The calibration strategy of n value is as follows: the maximum depth of chloride penetration is x_{f}, and the time required is

$${t}_{f} \cdot {x}_{f} = {λ}_{f} {t}_{f}^{n}$$

can be known from

$$λ = \frac{x}{{t}^{n}} ,$$

and given a data point (tᵢ, x_{fi}), where x_{f} is the penetration depth of chloride ions in concrete at tᵢ. For n∈[0, 1], search for nᵢ with a certain step size, and let x_{f}=λT, T=tⁿ. Based on the data point (tᵢ, x_{fi}), for each nᵢ, a straight line x_{f}=λT is fitted by linear regression. The nᵢ that best fits the data point to the straight line is chosen as the time index n.

The functional relationship between concentration and similar variables is expressed as (23):

$$C = {c}_{1} ( {e}^{- {c}_{2} λ} - {e}^{- {c}_{3} λ} ) + {c}_{4} \qquad ( 23 )$$

where

$$λ = \frac{x}{{t}^{n}}$$

and cᵢ (i=1,2,3,7) are coefficients to be determined, which are obtained by regression with the lsqcurvefit function.

In the present disclosure, conformal invariance analysis is performed, the exponential constraint formula (5) is derived by introducing the transformation group formula (2), and the existence formula (12) of the self-similar solution is determined. The time-dependent diffusion coefficient is also determined. When D varies with time equation (13), the transformation group equation (19) is adjusted, and a new invariant condition equation (17) is deduced to expand the applicable scope of the analytical solution. Aiming at the complex D relationship which cannot be calibrated, an approximate transformation equation (21) is used, combined with experimental data to calibrate parameter n, and a numerical method is used to solve the concentration distribution (22).

Example 1: taking the data from Magazine of Concrete Research Volume 67 Issue 18 980-987 as an example, the distribution maps of chloride concentrations in concrete in different saturation states are fitted.

TABLE 1
Working condition 1 (saturated concrete)

| Depth | Exposure time (year) | | | | | | |
|---|---|---|---|---|---|---|---|
| mm | 1 | 2 | 3 | 5 | 10 | 20 | 30 |
| 1 | 0.3167 | 0.322 | 0.3247 | 0.3277 | 0.3312 | 0.3342 | 0.3357 |
| 5 | 0.1924 | 0.2152 | 0.2273 | 0.2412 | 0.2578 | 0.2721 | 0.2794 |
| 10 | 0.0811 | 0.1101 | 0.1272 | 0.1483 | 0.1754 | 0.2001 | 0.2132 |
| 15 | 0.0255 | 0.046 | 0.0605 | 0.0805 | 0.1095 | 0.1386 | 0.1551 |
| 20 | 0.0059 | 0.0155 | 0.0242 | 0.0384 | 0.0625 | 0.0903 | 0.1073 |
| 25 | 0 | 0.0042 | 0.0081 | 0.0159 | 0.0324 | 0.0551 | 0.0705 |
| 30 | 0 | 0 | 0.0022 | 0.0057 | 0.0153 | 0.0314 | 0.0438 |
| 35 | 0 | 0 | 0 | 0.0018 | 0.0065 | 0.0167 | 0.0258 |
| 40 | 0 | 0 | 0 | 0 | 0.0025 | 0.0083 | 0.0143 |

TABLE 2
Working condition 2 (saturated concrete)

| Depth | Exposure time (year) | | | | | | |
|---|---|---|---|---|---|---|---|
| mm | 1 | 2 | 3 | 5 | 10 | 20 | 30 |
| 1 | 0.3476 | 0.3562 | 0.3606 | 0.3654 | 0.3711 | 0.3759 | 0.3783 |
| 5 | 0.1639 | 0.1965 | 0.2142 | 0.235 | 0.2602 | 0.2821 | 0.2934 |
| 10 | 0.0387 | 0.0674 | 0.0861 | 0.1112 | 0.1459 | 0.1797 | 0.1983 |
| 15 | 0.0054 | 0.0156 | 0.0252 | 0.0414 | 0.0696 | 0.1025 | 0.1228 |
| 20 | 0 | 0.0024 | 0.0053 | 0.012 | 0.028 | 0.0521 | 0.0693 |
| 25 | 0 | 0 | 0 | 0.0027 | 0.0094 | 0.0234 | 0.0355 |
| 30 | 0 | 0 | 0 | 0 | 0.0026 | 0.0093 | 0.0164 |
| 35 | 0 | 0 | 0 | 0 | 0 | 0.0032 | 0.0069 |
| 40 | 0 | 0 | 0 | 0 | 0 | 0 | 0.0026 |

TABLE 3
Working condition 3 (unsaturated concrete)

| Depth | Exposure time (year) | | | | | | |
|---|---|---|---|---|---|---|---|
| mm | 1 | 2 | 3 | 5 | 10 | 20 | 30 |
| 1 | 0.0457 | 0.823 | 0.1117 | 0.1559 | 0.2211 | 0.2794 | 0.3065 |
| 5 | 0.0226 | 0.0456 | 0.0656 | 0.0976 | 0.1489 | 0.1999 | 0.2261 |
| 10 | 0.0061 | 0.0158 | 0.0257 | 0.0437 | 0.0772 | 0.1165 | 0.1395 |
| 15 | 0 | 0.0037 | 0.0073 | 0.0150 | 0.0329 | 0.0587 | 0.0762 |
| 20 | 0 | 0 | 0 | 0.0039 | 0.0114 | 0.0253 | 0.0365 |
| 25 | 0 | 0 | 0 | 0 | 0.0032 | 0.0093 | 0.0153 |
| 30 | 0 | 0 | 0 | 0 | 0 | 0.0029 | 0.0056 |
| 35 | 0 | 0 | 0 | 0 | 0 | 0 | 0.0018 |

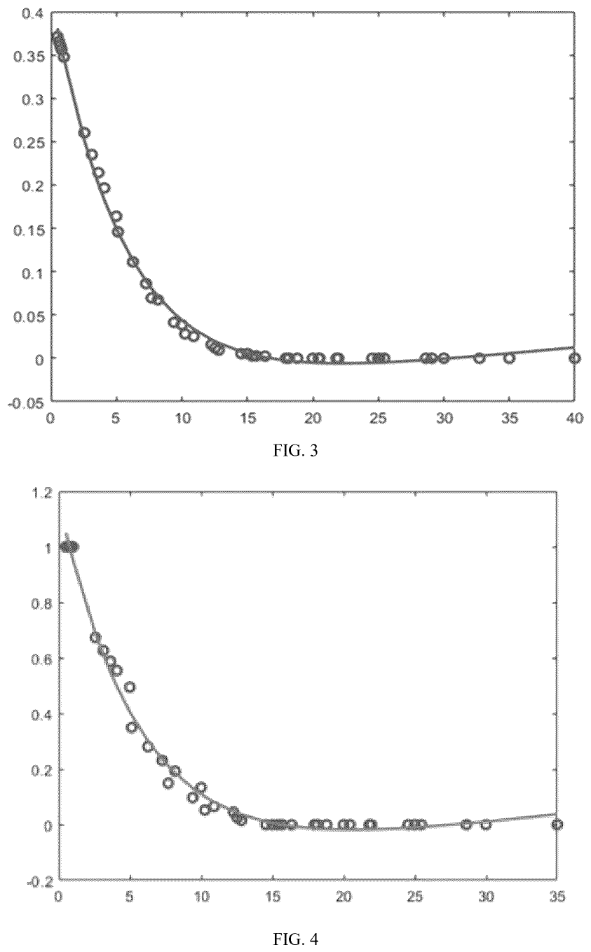

By using the method developed by the present disclosure, the data of the 1st, 2nd, 3rd, 5th, 10th, 20th, and 30th years under the above three working conditions are taken for fitting. As shown in FIG. 2, FIG. 3 and FIG. 4, the chloride concentration data in all working conditions can be fitted into a chloride concentration distribution curve. It is to be noted that working condition 3 is unsaturated concrete, and the chloride concentration varies greatly at the starting point (x=0). Therefore, it needs to be normalized (that is, the chloride concentration at the starting point is unified to 1), and the obtained result can still be fitted into a curve. All curve expressions are as follows:

$$C = - 0.5039 ( {e}^{- 0.0084 λ} - {e}^{- 0.1001 λ} ) + 0.3627 , λ = \frac{x}{{t}^{0.21}} \qquad ( working condition 1 )$$

$$C = 0.4723 ( {e}^{- 0.1799 λ} - {e}^{- 0.0036 λ} ) + 0.4217 , λ = \frac{x}{{t}^{0.29}} \qquad ( working condition 2 )$$

$$C = 1.3606 ( {e}^{- 0.1758 λ} - {e}^{- 0.0053 λ} ) + 1.1651 , λ = \frac{x}{{t}^{0.35}} \qquad ( working condition 3 )$$

By using the piecewise cubic Hermite interpolation method to predict the 30th-year chloride distribution data under three working conditions, and compared with the measured data, the root mean square error (RMSE) and coefficient of determination (R2) are used as the evaluation indicators for prediction quality. The results are as follows:

TABLE 4
Working condition 1 (predicted value)

| | Days of exposure (measured/predicted) | | | |
|---|---|---|---|---|
| Depth | 30 (predicted | 30 (measured | Absolute | |
| mm | measurement value) | value) | error | Error rate |
| 1 | 0.335754 | 0.3357 | 5.35E−05 | 0.000159 |
| 5 | 0.27842 | 0.2794 | −0.00098 | −0.00351 |
| 10 | 0.193395 | 0.2132 | −0.0198 | −0.09289 |
| 15 | 0.14161 | 0.1551 | −0.01349 | −0.08698 |
| 20 | 0.086387 | 0.1073 | −0.02091 | −0.1949 |
| 25 | 0.062252 | 0.0705 | −0.00825 | −0.11699 |
| 30 | 0.02917 | 0.0438 | −0.01463 | −0.33402 |
| 35 | 0.016135 | 0.0258 | −0.00967 | −0.37462 |
| 40 | 0.010902 | 0.0143 | −0.0034 | −0.23761 |

TABLE 5
Working condition 2 (predicted value)

| | Days of exposure (measured/predicted) | | | |
|---|---|---|---|---|
| Depth | 30 (predicted | 30 (measured | Absolute | |
| mm | measurement value) | value) | error | Error rate |
| 1 | 0.378336 | 0.3783 | 3.59E−05 | 9.5E−05 |
| 5 | 0.295159 | 0.2934 | 0.001759 | 0.005994 |
| 10 | 0.210981 | 0.1983 | 0.012681 | 0.063951 |
| 15 | 0.132237 | 0.1228 | 0.009437 | 0.076849 |
| 20 | 0.078179 | 0.0693 | 0.008879 | 0.128118 |
| 25 | 0.041891 | 0.0355 | 0.006391 | 0.180018 |
| 30 | 0.024597 | 0.0164 | 0.008197 | 0.499831 |
| 35 | 0.009338 | 0.0069 | 0.002438 | 0.353277 |
| 40 | 0.005033 | 0.0026 | 0.002433 | 0.935918 |

TABLE 6
Working condition 3 (predicted value)

| | Days of exposure (measured/predicted) | | | |
|---|---|---|---|---|
| Depth | 30 (predicted | 30 (measured | Absolute | |
| mm | measurement value) | value) | error | Error rate |
| 1 | 1 | 1 | 0 | 0 |
| 5 | 0.794927 | 0.737684 | 0.057243 | 0.077599 |
| 10 | 0.616653 | 0.455139 | 0.161515 | 0.354869 |
| 15 | 0.361262 | 0.248613 | 0.112648 | 0.453106 |
| 20 | 0.236667 | 0.119086 | 0.117581 | 0.987358 |
| 25 | 0.171206 | 0.049918 | 0.121288 | 2.42972 |
| 30 | 0.070245 | 0.018271 | 0.051974 | 2.84467 |
| 35 | 0.010537 | 0.005873 | 0.004664 | 0.794144 |

TABLE 7
Evaluation indicators for prediction quality

| Working conditions | RMSE | R² |
|---|---|---|
| Working condition 1 | 0.01247 | 0.9941 |
| Working condition 2 | 0.007084 | 0.9969 |
| Working condition 3 | 0.095729 | 0.9285 |

It can be seen from Table 7 that under different working conditions, the RMSE values of the predicted values of chloride distribution in concrete are all less than 0.1, indicating that the predicted values differ extremely little from the true values. In addition, under different curing ages, R2 values of chloride distribution in concrete are bigger than 0.92, indicating that chloride distribution curves under the above three conditions have high fitting accuracy.

Example 2: taking the data of Construction and Building Materials 368(2023)130411 as an example, the distribution maps of chloride concentrations in concrete under different curing ages are fitted.

TABLE 8
Curing for 3 days

| Depth | Exposure time (day) | | | | | | | |
|---|---|---|---|---|---|---|---|---|
| mm | 40 | 80 | 120 | 160 | 200 | 240 | 280 | 320 |
| 0.932 | 0.552 | 0.787 | 1.036 | 1.157 | 1.255 | 1.475 | 1.611 | 1.618 |
| 2.983 | 0.386 | 0.605 | 0.824 | 1.021 | 1.082 | 1.255 | 1.354 | 1.528 |
| 5.966 | 0.212 | 0.424 | 0.605 | 0.726 | 0.832 | 1.021 | 1.104 | 1.180 |
| 10.068 | 0.061 | 0.197 | 0.325 | 0.454 | 0.560 | 0.643 | 0.787 | 0.870 |
| 13.983 | 0.015 | 0.068 | 0.166 | 0.250 | 0.333 | 0.424 | 0.484 | 0.613 |
| 18.085 | 0 | 0.023 | 0.068 | 0.113 | 0.166 | 0.242 | 0.295 | 0.371 |
| 21.814 | 0 | 0.008 | 0.023 | 0.045 | 0.091 | 0.129 | 0.174 | 0.219 |
| 25.915 | 0 | 0 | 0.008 | 0.015 | 0.038 | 0.053 | 0.091 | 0.129 |
| 30.017 | 0 | 0 | 0 | 0.008 | 0.015 | 0.023 | 0.045 | 0.061 |
| 34.119 | 0 | 0 | 0 | 0 | 0.008 | 0.015 | 0.023 | 0.030 |
| 38.034 | 0 | 0 | 0 | 0 | 0 | 0.008 | 0.008 | 0.015 |
| 42.136 | 0 | 0 | 0 | 0 | 0 | 0 | 0 | 0.008 |
| 46.051 | 0 | 0 | 0 | 0 | 0 | 0 | 0 | 0 |
| 49.966 | 0 | 0 | 0 | 0 | 0 | 0 | 0 | 0 |

TABLE 9
Curing for 7 days

| Depth | Exposure time (day) | | | | | | | |
|---|---|---|---|---|---|---|---|---|
| mm | 40 | 80 | 120 | 160 | 200 | 240 | 280 | 320 |
| 1.115 | 0.437 | 0.618 | 0.800 | 0.955 | 1.082 | 1.129 | 1.297 | 1.385 |
| 3.159 | 0.296 | 0.484 | 0.679 | 0.787 | 0.901 | 0.955 | 1.150 | 1.190 |
| 6.132 | 0.148 | 0.309 | 0.464 | 0.592 | 0.659 | 0.773 | 0.887 | 0.982 |
| 10.034 | 0.040 | 0.141 | 0.235 | 0.343 | 0.430 | 0.497 | 0.578 | 0.672 |
| 14.122 | 0.007 | 0.054 | 0.121 | 0.175 | 0.235 | 0.336 | 0.397 | 0.444 |
| 18.024 | 0 | 0.013 | 0.047 | 0.081 | 0.121 | 0.175 | 0.222 | 0.276 |
| 22.111 | 0 | 0 | 0.013 | 0.034 | 0.061 | 0.087 | 0.128 | 0.175 |
| 26.014 | 0 | 0 | 0.008 | 0.013 | 0.020 | 0.040 | 0.067 | 0.094 |
| 29.916 | 0 | 0 | 0 | 0.008 | 0.013 | 0.020 | 0.034 | 0.047 |
| 34.189 | 0 | 0 | 0 | 0 | 0.007 | 0.007 | 0.020 | 0.020 |
| 37.905 | 0 | 0 | 0 | 0 | 0 | 0 | 0.007 | 0.007 |
| 41.993 | 0 | 0 | 0 | 0 | 0 | 0 | 0 | 0.007 |
| 46.081 | 0 | 0 | 0 | 0 | 0 | 0 | 0 | 0 |

TABLE 10
Curing for 14 days

| Depth | Exposure time (day) | | | | | | | |
|---|---|---|---|---|---|---|---|---|
| mm | 40 | 80 | 120 | 160 | 200 | 240 | 280 | 320 |
| 0.932 | 0.329 | 0.481 | 0.618 | 0.694 | 0.795 | 0.851 | 0.962 | 0.972 |
| 2.983 | 0.218 | 0.365 | 0.471 | 0.557 | 0.689 | 0.714 | 0.856 | 0.856 |
| 5.966 | 0.096 | 0.228 | 0.329 | 0.420 | 0.496 | 0.577 | 0.668 | 0.689 |
| 10.068 | 0.020 | 0.091 | 0.162 | 0.238 | 0.314 | 0.395 | 0.425 | 0.486 |
| 13.983 | 0.005 | 0.025 | 0.071 | 0.122 | 0.172 | 0.233 | 0.278 | 0.339 |
| 17.898 | 0 | 0.005 | 0.025 | 0.056 | 0.086 | 0.167 | 0.167 | 0.167 |
| 22.000 | 0 | 0 | 0.005 | 0.020 | 0.041 | 0.061 | 0.096 | 0.127 |
| 26.102 | 0 | 0 | 0.005 | 0.005 | 0.010 | 0.025 | 0.046 | 0.066 |
| 29.916 | 0 | 0 | 0 | | 0.005 | 0.015 | 0.020 | 0.035 |
| 30.017 | 0 | 0 | 0 | 0 | 0 | 0.005 | 0.010 | 0.015 |
| 33.932 | 0 | 0 | 0 | 0 | 0 | 0 | 0.005 | 0.005 |
| 38.034 | 0 | 0 | 0 | 0 | 0 | 0 | 0 | 0.005 |
| 42.136 | 0 | 0 | 0 | 0 | 0 | 0 | 0 | 0 |
| 46.051 | 0 | 0 | 0 | 0 | 0 | 0 | 0 | 0 |

TABLE 11
Curing for 28 days

| Depth | Exposure time (day) | | | | | | | |
|---|---|---|---|---|---|---|---|---|
| mm | 40 | 80 | 120 | 160 | 200 | 240 | 280 | 320 |
| 1.115 | 0.270 | 0.388 | 0.523 | 0.582 | 0.646 | 0.738 | 0.781 | 0.814 |
| 3.159 | 0.181 | 0.304 | 0.414 | 0.477 | 0.553 | 0.591 | 0.692 | 0.717 |
| 5.946 | 0.080 | 0.186 | 0.270 | 0.329 | 0.422 | 0.456 | 0.532 | 0.582 |
| 10.034 | 0.017 | 0.072 | 0.139 | 0.203 | 0.270 | 0.321 | 0.380 | 0.414 |
| 13.936 | 0 | 0.021 | 0.063 | 0.105 | 0.152 | 0.194 | 0.241 | 0.274 |
| 18.024 | 0 | 0.008 | 0.021 | 0.046 | 0.072 | 0.105 | 0.139 | 0.173 |
| 21.926 | 0 | 0 | 0.004 | 0.017 | 0.030 | 0.055 | 0.080 | 0.105 |
| 26.014 | 0 | 0 | 0 | 0.004 | 0.013 | 0.021 | 0.034 | 0.055 |
| 30.101 | 0 | 0 | 0 | 0 | 0.004 | 0.008 | 0.017 | 0.025 |
| 34.189 | 0 | 0 | 0 | 0 | 0 | 0.004 | 0.008 | 0.013 |
| 38.091 | 0 | 0 | 0 | 0 | 0 | 0 | 0.004 | 0.008 |
| 41.993 | 0 | 0 | 0 | 0 | 0 | 0 | 0 | 0.004 |
| 46.081 | 0 | 0 | 0 | 0 | 0 | 0 | 0 | 0 |
| 49.983 | 0 | 0 | 0 | 0 | 0 | 0 | 0 | 0 |

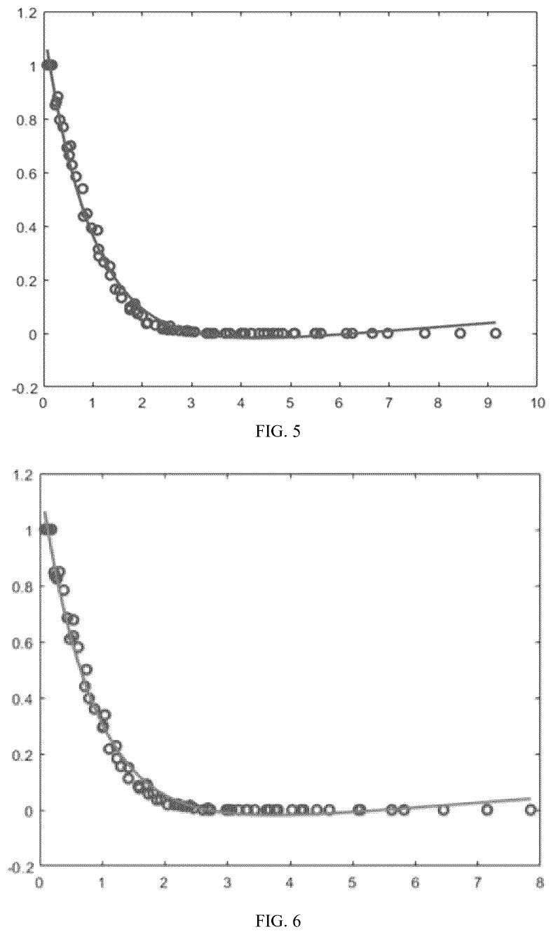

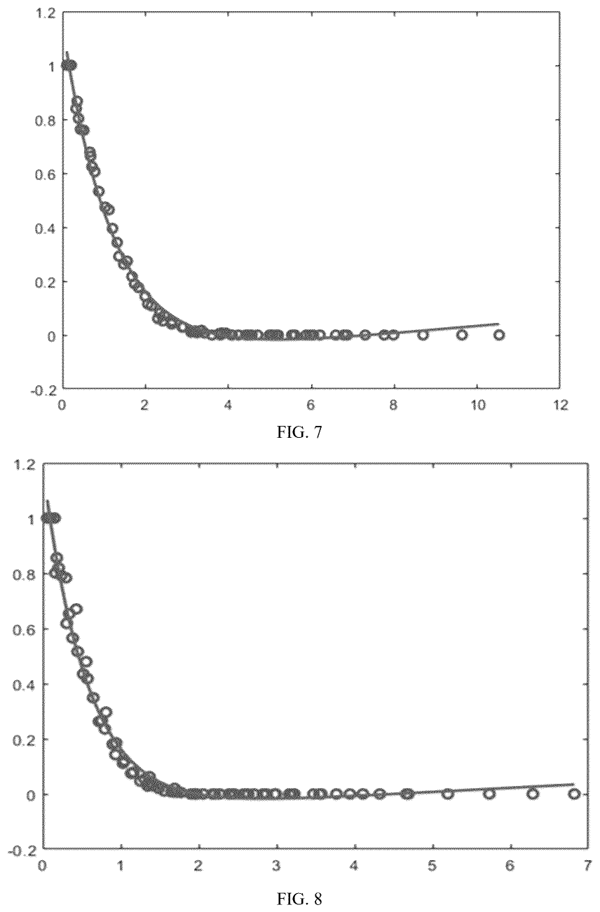

By using the method developed by the present disclosure, the data on the 40th day, 80th day, 120th day, 160th day, 200th day, 240th day, 280th day, and 320th day at the above different curing ages are used for fitting. Because the concrete under this working condition is unsaturated concrete, normalization treatment is required. The fitting results are shown in FIG. 5, FIG. 6, FIG. 7 and FIG. 8. The chloride concentration data at all curing ages can be fitted into a chloride concentration distribution curve, and the expressions are respectively as follows:

$$C = 1.2521 ( {e}^{- 1.0245 λ} - {e}^{- 0.0132 λ} ) + 1.1498 , λ = \frac{x}{{t}^{0.43}} ( 3 days of curing )$$

$$C = 1.2849 ( {e}^{- 1.1873 λ} - {e}^{- 0.0153 λ} ) + 1.1798 , λ = \frac{x}{{t}^{0.51}} ( 7 days of curing )$$

$$C = 1.2668 ( {e}^{- 0.8278 λ} - {e}^{- 0.0122 λ} ) + 1.1553 , λ = \frac{x}{{t}^{0.44}} ( 14 days of curing )$$

$$C = 1.2573 ( {e}^{- 1.7522 λ} - {e}^{- 0.0128 λ} ) + 1.1866 , λ = \frac{x}{{t}^{0.56}} ( 28 days of curing )$$

By using the piecewise cubic Hermite interpolation method to predict chloride distribution data for 320 days at 4 curing ages, and compared with the measured results, the RMSE and coefficient of determination R² are used as the evaluation indicators for prediction quality. The results are as follows:

TABLE 12
Curing for 3 days (predicted)

| | Days of exposure (measured/predicted) | | | |
|---|---|---|---|---|
| Depth | 320 (predicted | 320 (measured | Absolute | |
| mm | measurement value) | value) | error | Error rate |
| 0.932 | 1 | 1 | 0 | 0 |
| 2.983 | 0.857103 | 0.944376 | −0.0872723 | −0.09241 |
| 5.966 | 0.709601 | 0.729295 | −0.0196949 | −0.02701 |
| 10.068 | 0.51256 | 0.537701 | −0.0251411 | −0.04676 |
| 13.983 | 0.389421 | 0.378863 | 0.01055828 | 0.027868 |
| 18.085 | 0.254058 | 0.229295 | 0.0247621 | 0.107992 |
| 21.814 | 0.144686 | 0.135352 | 0.00933323 | 0.068955 |
| 25.915 | 0.082818 | 0.079728 | 0.00309013 | 0.038758 |
| 30.017 | 0.038448 | 0.037701 | 0.00074725 | 0.019821 |
| 34.119 | 0.024232 | 0.018541 | 0.00569103 | 0.306936 |
| 38.034 | 0.010777 | 0.009271 | 0.00150661 | 0.162513 |
| 42.136 | 0.006179 | 0.004944 | 0.00123449 | 0.249675 |
| 46.051 | 0 | 0 | 0 | 0 |
| 49.966 | 0 | 0 | 0 | 0 |

TABLE 13
Curing for 7 days (predicted)

| | Days of exposure (measured/predicted) | | | |
|---|---|---|---|---|
| Depth | 320 (predicted | 320 (measured | Absolute | |
| mm | measurement value) | value) | error | Error rate |
| 1.115 | 1 | 1 | 0 | 0 |
| 3.159 | 1 | 0.859206 | 0.140794 | 0.163866 |
| 6.132 | 0.812836 | 0.709025 | 0.103811 | 0.146414 |
| 10.034 | 0.590918 | 0.485199 | 0.105719 | 0.217888 |
| 14.122 | 0.364471 | 0.320578 | 0.043894 | 0.13692 |
| 18.024 | 0.21127 | 0.199278 | 0.011992 | 0.060175 |
| 22.111 | 0.118309 | 0.126354 | −0.00804 | −0.06367 |
| 26.014 | 0.082565 | 0.06787 | 0.014695 | 0.216519 |
| 29.916 | 0.045146 | 0.033935 | 0.011211 | 0.330364 |
| 34.189 | 0.017917 | 0.01444 | 0.003477 | 0.240784 |
| 37.905 | 0.012243 | 0.005054 | 0.007189 | 1.422363 |
| 41.993 | 0.004181 | 0.005054 | −0.00087 | −0.17281 |
| 46.081 | 0 | 0 | 0 | 0 |

TABLE 14
Curing for 14 days (predicted)

| | Days of exposure (measured/predicted) | | | |
|---|---|---|---|---|
| Depth | 320 (predicted | 320 (measured | Absolute | |
| mm | measurement value) | value) | error | Error rate |
| 0.932 | 1 | 1 | 0 | 0 |
| 2.983 | 0.922569 | 0.880658 | 0.041911 | 0.047591 |
| 5.966 | 0.724995 | 0.708848 | 0.016147 | 0.02278 |
| 10.068 | 0.465397 | 0.5 | −0.0346 | −0.06921 |
| 13.983 | 0.325452 | 0.348765 | −0.02331 | −0.06685 |
| 17.898 | 0.201736 | 0.171811 | 0.029926 | 0.174179 |
| 22 | 0.108268 | 0.130658 | −0.02239 | −0.17137 |
| 26.102 | 0.051821 | 0.067901 | −0.01608 | −0.23682 |
| 30.017 | 0.02835 | 0.036008 | −0.00766 | −0.21269 |
| 33.932 | 0.010207 | 0.015432 | −0.00523 | −0.33862 |
| 38.034 | 0.00416 | 0.005144 | −0.00098 | −0.19125 |
| 42.136 | 0 | 0.005144 | −0.00514 | −1 |
| 46.051 | 0 | 0 | 0 | 0 |
| 49.966 | 0 | 0 | 0 | 0 |

TABLE 15
Curing for 28 days (predicted)

| | Days of exposure (measured/predicted) | | | |
|---|---|---|---|---|
| Depth | 320 (predicted | 320 (measured | Absolute | |
| mm | measurement value) | value) | error | Error rate |
| 1.115 | 1 | 1 | 0 | 0 |
| 3.259 | 0.901652 | 0.880835 | 0.020817 | 0.023633 |
| 5.946 | 0.756397 | 0.714988 | 0.041409 | 0.057916 |
| 10.034 | 0.518316 | 0.5086 | 0.009717 | 0.019105 |
| 13.936 | 0.379082 | 0.336609 | 0.042473 | 0.126178 |
| 18.024 | 0.236993 | 0.212531 | 0.024463 | 0.115102 |
| 21.926 | 0.184863 | 0.128993 | 0.055871 | 0.433131 |
| 26.014 | 0.07558 | 0.067568 | 0.008012 | 0.118578 |
| 30.101 | 0.053971 | 0.030713 | 0.023259 | 0.757312 |
| 34.189 | 0.018563 | 0.015971 | 0.002593 | 0.162346 |
| 38.091 | 0.007385 | 0.009828 | −0.00244 | −0.24857 |
| 41.993 | 0.00388 | 0.004914 | −0.00103 | −0.21049 |
| 46.081 | 0 | 0 | 0 | 0 |
| 49.983 | 0 | 0 | 0 | 0 |

TABLE 16
Evaluation indicators for prediction quality

| Curing ages | RMSE | R² |
|---|---|---|
| Curing for 3 days | 0.026042 | 0.994055 |
| Curing for 7 days | 0.058387 | 0.976347 |
| Curing for 14 days | 0.020619 | 0.996598 |
| Curing for 28 days | 0.024473 | 0.995028 |

It can be seen from Table 16 that under different curing ages, the RMSE values of the predicted values of chloride distribution in concrete after 320 days of chloride immersion are all less than 0.1, indicating that the predicted values differ extremely little from the true values. In addition, under different curing ages, R2 values of the predicted chloride distribution in concrete after 320 days of chloride immersion are all greater than 0.97, indicating that the chloride distribution curves at the above four curing ages all have high fitting accuracy.

To further verify the accuracy of the method developed in the present disclosure. Two time-varying models of chloride concentration, the exponential function model and the logarithmic function model, are used to fit the four groups of data in Example 2, and the obtained R2 values are shown in Table 17.

TABLE 17
R² for different models

| | R² | | |
|---|---|---|---|
| | Exponential | Logarithmic | Model developed by the |
| Curing ages | function model | function model | present disclosure |
| Curing for | 0.9598 | 0.9686 | 0.9941 |
| 3 days | | | |
| Curing for | 0.9609 | 0.9628 | 0.9763 |
| 7 days | | | |
| Curing for | 0.9484 | 0.9635 | 0.9966 |
| 14 days | | | |
| Curing for | 0.9640 | 0.9782 | 0.9952 |
| 28 days | | | |

Obviously, the R2 values after fitting the four groups of data in Example 2 by the model developed by the present disclosure are all higher than the R2 values after fitting the exponential function model and the logarithmic function model. The high accuracy of the model developed by the present disclosure is demonstrated.

For parts not described in detail in the present disclosure, reference may be made to the related art or the well-known technology of those skilled in the art, which is not limited in this example and will not be described in detail here.

The examples of the present disclosure have been described above with reference to the accompanying drawings. However, the present disclosure is not limited to the above specific embodiments. The above specific embodiments are merely illustrative and not restrictive. Under the teaching of the present disclosure, those ordinary skilled in the art can also make many forms without departing from the spirit of the present disclosure and the protection scope of the claims, which all belong to the protection of the present disclosure.

1. A method for revealing chloride distribution in a concrete diffusion zone, comprising the steps of:
determining a nonlinear diffusion equation capable of expressing chloride diffusion in concrete;
determining a single parameter transformation group to be introduced, and substituting the single parameter transformation group into the nonlinear diffusion equation to obtain a first transformation formula;
solving, for the first transformation formula, the equation according to a conformal invariance condition, a given initial condition and a boundary condition when a chloride diffusion coefficient is constant, and obtaining an analytical expression of chloride concentration distribution when the chloride diffusion coefficient is constant; and/or,
solving, for the first transformation formula, the equation according to a conformal invariance condition, a given initial condition and a boundary condition when the chloride diffusion coefficient changes with time, and obtaining a first analytical expression of chloride concentration distribution when the chloride diffusion coefficient changes with time.

2. The method for revealing chloride distribution in a concrete diffusion zone according to claim 1, wherein the conformal invariance condition when the chloride diffusion coefficient is constant comprises:
β₁=2β₂ and β₃ are arbitrary constants; β₁, β₂ and β₃ are indexes to be determined for time t, penetration depth x, and concentration C in the single parameter transformation group; and
invariant transformation conditions:
$$λ = \frac{x}{{t}^{{β}_{2} / {β}_{1}}} , f = \frac{C}{{t}^{{β}_{3} / {β}_{1}}} .$$

3. The method for revealing chloride distribution in a concrete diffusion zone according to claim 1, wherein the initial conditions when the chloride diffusion coefficient is constant and when the chloride diffusion coefficient changes with time are as follows:
$$C ( 0 , x ) = {C}_{i}$$
the boundary conditions are:
$$\{ \begin{matrix}C ( t , 0 ) = {C}_{0} \\ C ( t , ∞ ) = {C}_{i}\end{matrix}$$
where C₀ is a concentration corresponding to a chloride penetration depth x=0, and Cᵢ is a concentration corresponding to a depth of chloride penetration x=i.

4. The method for revealing chloride distribution in a concrete diffusion zone according to claim 1, wherein an expression of the chloride diffusion coefficient D changing with time is as follows:
$$D = {{D}_{test} ( \frac{{t}_{test}}{t} )}^{m}$$
where tₜₑₛₜ is a test time, Dₜₑₛₜ is a corresponding diffusion coefficient at the test time tₜₑₛₜ, and m is an age coefficient.

5. The method for revealing chloride distribution in a concrete diffusion zone according to claim 1, wherein the conformal invariance condition when the chloride diffusion coefficient changes with time is as follows:
(1+m)β₁=2β₂ and β₃ are arbitrary constants;
where β₁, β₂ and β₃ are indexes to be determined for time t, penetration depth x, and concentration C in the single parameter transformation group, and m is the age coefficient.

6. The method for revealing chloride distribution in a concrete diffusion zone according to claim 1, further comprising the steps of:
determining an approximately invariant transformation, and substituting the approximately invariant transformation into the nonlinear diffusion equation to obtain a second transformation formula; and
solving, for the second transformation formula, the equation according to initial and boundary conditions to obtain the second analytical expression of chloride concentration distribution when the chloride diffusion coefficient changes with time.

7. The method for revealing chloride distribution in a concrete diffusion zone according to claim 6, wherein the approximately invariant transformation is as follows:
$$λ = \frac{x}{{t}^{n}} , C = C ( λ )$$
where n is a time index to be determined, t is time, x is penetration depth, and C is a chloride concentration.

8. The method for revealing chloride distribution in a concrete diffusion zone according to claim 6, wherein a relationship between the chloride diffusion coefficient and concentration and time is calibrated as follows:
a chloride concentration is a function of an independent variable the distribution law of
$$λ = \frac{x}{{t}^{n}} ,$$
the distribution law of chloride concentration is calibrated by determining the time index n, and the relationship between the chloride diffusion coefficient and concentration and time is determined; and
a determination process of the value of n comprises the steps of: recording the maximum depth of chloride penetration as x_{f}, and a required time as t_{f}; deriving
$${x}_{f} = {λ}_{f} {t}_{f}^{n}$$
based on
$$λ = \frac{x}{{t}^{n}} ;$$
taking the given data point (tᵢ, x_{fi}), where x_{f} is an infiltration depth of chloride in concrete at tᵢ; searching, for n∈[0, 1], nᵢ with a certain step size, and making x_{f}=λT, T=tⁿ; fitting a straight line x=λT using linear regression for each nᵢ based on the data point (tᵢ, x_{fi}); and choosing the nᵢ that best fits the data point to a straight line as the time index n.

9. A computer program product, comprising a computer program, which, when executed by a processor, implements the steps of the method for revealing chloride distribution in a concrete diffusion zone according to claim 1.

10. A computer program product, comprising a computer program, which, when executed by a processor, implements the steps of the method for revealing chloride distribution in a concrete diffusion zone according to claim 2.

11. A computer program product, comprising a computer program, which, when executed by a processor, implements the steps of the method for revealing chloride distribution in a concrete diffusion zone according to claim 3.

12. A computer program product, comprising a computer program, which, when executed by a processor, implements the steps of the method for revealing chloride distribution in a concrete diffusion zone according to claim 4.

13. A computer program product, comprising a computer program, which, when executed by a processor, implements the steps of the method for revealing chloride distribution in a concrete diffusion zone according to claim 5.

14. A computer program product, comprising a computer program, which, when executed by a processor, implements the steps of the method for revealing chloride distribution in a concrete diffusion zone according to claim 6.

15. A computer program product, comprising a computer program, which, when executed by a processor, implements the steps of the method for revealing chloride distribution in a concrete diffusion zone according to claim 7.

16. A computer program product, comprising a computer program, which, when executed by a processor, implements the steps of the method for revealing chloride distribution in a concrete diffusion zone according to claim 8.

17. A computer device, comprising a memory, a processor, and a computer program stored on the memory and executable on the processor, wherein the processor executes the computer program to implement the steps of the method for revealing chloride distribution in a concrete diffusion zone according to claim 1.

18. A computer device, comprising a memory, a processor, and a computer program stored on the memory and executable on the processor, wherein the processor executes the computer program to implement the steps of the method for revealing chloride distribution in a concrete diffusion zone according to claim 2.

19. A computer device, comprising a memory, a processor, and a computer program stored on the memory and executable on the processor, wherein the processor executes the computer program to implement the steps of the method for revealing chloride distribution in a concrete diffusion zone according to claim 3.

20. A computer device, comprising a memory, a processor, and a computer program stored on the memory and executable on the processor, wherein the processor executes the computer program to implement the steps of the method for revealing chloride distribution in a concrete diffusion zone according to claim 4.
